(19) United States
(12) Patent Application Publication
(10) Pub. No.: US 2010/0217940 A1
(43) Pub. Date: Aug. 26, 2010

(54) Centrifugal separator

(75) Inventor: Mizuyoshi Shibutani, Tokyo (JP)

Correspondence Address: POSZ LAW GROUP, PLC, 12040 SOUTH LAKES DRIVE, SUITE 101, RESTON, VA, 20191, US

(73) Assignee: TOMY KOGYO CO., LTD., Tokyo (JP)

(21) Appl. No.: 12/453,945

(22) Filed: May 28, 2009

(30) Foreign Application Priority Data
Feb. 24, 2009 (JP) 2009-041545

(51) Int. Cl. G06F 12/00

(52) U.S. Cl. 711/153; 711/E12.001

(57) ABSTRACT

To propose a centrifugal separator that is capable of performing, easily and accurately, a condition setting operation for continuously operating the centrifugal separator under a plurality of operating conditions. In the centrifugal separator, which stores operating conditions in a plurality of memories respectively and independently or continuously calls up the operating conditions stored in these memories to perform operation control, a plurality of memory selection keys corresponding to the plurality of memories are provided, and the memories for storing the operating conditions therein and the memories for calling up the operating conditions are specified by selecting the memory selection keys.

### BACKGROUND OF THE INVENTION

1. Field of the Invention

The present invention relates to a centrifugal separator, and particularly to a centrifugal separator that is continuously operated under a plurality of operating conditions.

2. Description of the Related Art

Japanese Examined Patent Application Publication (Kokoku) No. H7-181 discloses a centrifugal separator for setting memory numbers for a plurality of operating conditions, registering the memory numbers in a storage device, calling up the operating conditions based on the memory numbers by using the storage device, and operating and controlling the centrifugal separator, wherein specific memory numbers different from the memory numbers for continuous operation are provided, the operating conditions are registered in the storage device in the order of the specific memory numbers, and the operation of the centrifugal separator is continued sequentially by calling up the first registered operating condition by means of the first memory number to operate the centrifugal separator, and automatically calling up the operating condition registered next by means of the next memory number upon completion of the first operation.

Incidentally, in the application field of a centrifugal separator, a variety of reagent kits for extractive purification application is provided for the researches, and it is most often the case that the operating conditions are changed and the centrifugal separator is operated continuously in the order corresponding to a specific operating order. For example, sometimes the centrifugal separator is operated under the conditions of the first preset temperature, the first rotating speed, and the first operating time, and subsequently the centrifugal separator is operated under the conditions of the second preset temperature, the second rotating speed, and the second operating time. In this case, a specific relation is required between the first operating condition and the second operating condition, namely, a condition that, for example, the first rotating speed is always lower than the second rotating speed is required.

In this case, the centrifugal separator according to the conventional technology has poor operability and thus tends to cause inputting errors or other operational errors. In other words, for example, in the technology disclosed in Japanese Examined Patent Application Publication (Kokoku) No. H7-181, the specific memory numbers are used when continuously operating the centrifugal separator under the plurality of operating conditions, and the operating conditions need to be registered in the order of the specific memory numbers. Therefore, there are a number of processes required for setting each operating condition, making the operation of the centrifugal separator troublesome. In addition, the first operating condition and the subsequent operating condition are set conversely, easily causing an operational error.

### SUMMARY OF THE INVENTION

An object of the present invention, therefore, is to propose a centrifugal separator that is capable of performing, easily and accurately, a condition setting operation for continuously operating the centrifugal separator under a plurality of operating conditions.

The object described above was resolved by the following (1) to (5) inventions.

(1) A centrifugal separator, which stores operating conditions in a plurality of memories respectively and independently or continuously calls up the operating conditions stored in these memories, to perform operation control, wherein a plurality of memory selection keys corresponding to the plurality of memories are provided, and the memories for storing the operating conditions therein and the memories for calling up the operating conditions are specified by selecting the memory selection keys.
(2) The centrifugal separator described in (1) above, wherein an order of the memories for calling up the operating conditions is previously specified, regardless of an order of selecting the memory selection keys.
(3) The centrifugal separator described in (2) above, wherein the memories are divided into a plurality of groups, and the order of the memories for calling up the operating conditions is previously specified in each of the groups of the divided memories.
(4) The centrifugal separator described in (2) or (3) above, wherein the order of the memories for calling up the operating conditions is previously specified such as to call up the operating conditions in ascending order of memory numbers of the memories specified by selecting the memory selection keys.
(5) The centrifugal separator described in (2) or (3) above, wherein the order of the memories for calling up the operating conditions is previously specified such as to call up the operating conditions in the order of the memories storing operating conditions of low rotating speeds, out of the memories specified by selecting the memory selection keys.

According to the centrifugal separator according to the present invention, a key for specifying the memories storing the operating conditions and a key for specifying the memories calling up the operating conditions are the same memory selection keys. Therefore, an extremely good operability is achieved. In addition, when the order of the memories calling up the operating conditions is specified beforehand in the centrifugal separator regardless of the order of selecting the memory selection key, the centrifugal separator can be continuously operated reliably in different order of specific operating conditions, such as in the order of the operating conditions in which the rotating speed is always low, whereby the operability of the centrifugal separator is improved. Furthermore, additional keys for continuous operation are not required so that the space for the panel can be saved and the cost can be reduced.

### BRIEF DESCRIPTION OF THE DRAWINGS

FIG. 1 is a schematic plan view showing an example of a panel part in an embodiment of a centrifugal separator according to the present invention;

FIG. 2 is a flowchart showing an example of a procedure for storing operating conditions in memories;

FIG. 3 is a flowchart showing an example of operating the centrifugal separator; and

FIG. 4 is a block diagram showing an example of an electronic circuit.

### DESCRIPTION OF THE PREFERRED EMBODIMENTS

An embodiment of the above-described centrifugal separator according to the present invention is described hereinafter in detail with reference to the drawings.

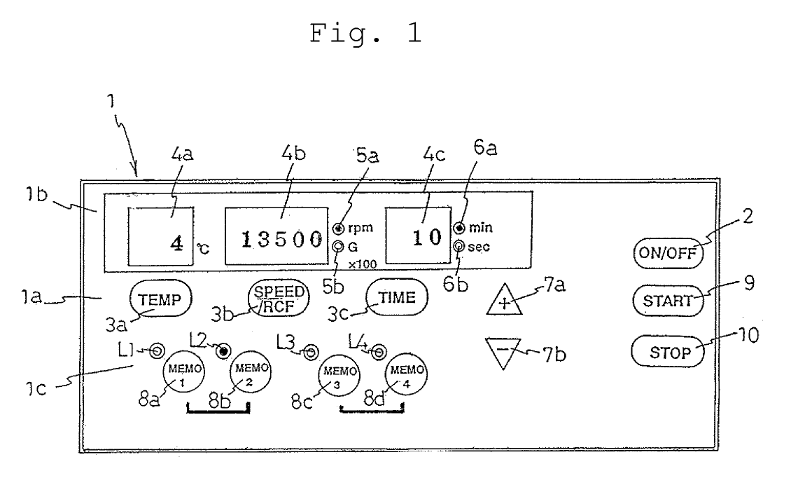

FIG. 1 is a schematic diagram showing an example of a panel part in an embodiment of the centrifugal separator according to the present invention.

This panel 1 has an input part 1a for setting and executing operating conditions of the centrifugal separator, a parameter value display part 1b, a memory selecting part 1c, and the like. This panel 1 is also configured such as to input a parameter value of an operating condition composed of a combination of temperature (TEMP), rotating speed/centrifugal acceleration (SPEED/RCF), operating time (TIME).

The values of the temperature, rotating speed/centrifugal acceleration, and operating time are set by selecting one of operating condition selection keys 3a, 3b, 3c corresponding to the above operating conditions, and thereafter changing display values of temperature display means 4a, speed display means 4b, and operating time display means 4c by means of a set value increase key 7a and a set value decrease key 7b.

Turning a power switch 2 on displays an initial set value of the temperature (4, for example) on the temperature display means 4a, an initial set value of the rotating speed (13500, for example) on the speed display means 4b, and an initial set value of the operating time by the minute (10, for example) on the operating time display means 4c. Note that the initial set values described here merely indicate the set values of the operating conditions used most recently.

A rotating speed mode and a centrifugal acceleration mode are switched by pressing the operating condition selection key 3b. In the centrifugal acceleration mode, an initial set value of the centrifugal acceleration (17730, for example) is displayed on the speed display means 4b. Pressing the operating condition selection key 3b again returns the mode to the rotating speed mode and displays the initial set value of the rotating speed (13500, for example) on the speed display means 4b again. In the case of the rotating speed mode, rotating speed mode display means 5a disposed in the vicinity of a character “rpm” lights up. In the case of the centrifugal acceleration mode, centrifugal acceleration mode display means 5b disposed in the vicinity of a character “G” lights up.

The set value increase key 7a and the set value decrease key 7b are used to change the initial set values. For example, the operating condition selection key 3a is pressed to select the temperature, and thereafter the value displayed on the temperature display means 4a is incremented, namely, increased by a predetermined value, by pressing the set value increase key 7a. Conversely, the value displayed on the temperature display means 4a is decremented, namely, decreased by a predetermined value, by pressing the set value decrease key 7b. The value is increased or decreased in this manner to set the temperature at a desired temperature. The rotating speed or centrifugal acceleration is similarly set at a desired value by pressing the operating condition selection key 3b. The operating time by the minute or second is similarly set at a desired value by pressing the operating condition selection key 3c.

Switching between a minute unit mode and a second unit mode is performed in conjunction with the operations of the set value increase key 7a and the set value decrease key 7b. Specifically, the display values can be changed by operating the set value increase key 7a or set value decrease key 7b on a 10-second time scale between 10 to 50 seconds and on a 1-minute time scale between 1 minute to 99 minutes. Therefore, the mode is switched to the minute unit mode and [1] minute is displayed by pressing the set value increase key 7a when the display value on the operating time display means 4c is [50] seconds, and the mode is switched to the second unit mode and [50] seconds is displayed by pressing the set value decrease key 7b when the display value on the operating time display means 4c is [1] minute. In the case of the minute unit mode, minute unit mode display means 6a disposed in the vicinity of a character “min” lights up. In the case of the second unit mode, second unit mode display means 6b disposed in the vicinity of a character “sec” lights up.

After setting all of the parameter values of the operating conditions at desired values, one memory selection key is selected from memory selection keys 8a, 8b, 8c and 8d (the memory selection key 8a, for example) corresponding to a memory M1 (MEMO1), memory M2 (MEMO2), memory M3 (MEMO3) and memory M4 (MEMO4) respectively, and the selected memory selection key is pressed for a long time (for approximately three seconds, for example) to store the parameter values of the operating conditions into the corresponding memory (the memory M1, for example), the operating conditions being set in the above process.

Similarly, after changing the parameter values of the operating conditions, another memory selection key (the memory selection key 8b, for example) is selected and pressed for a long time to store the values into the corresponding memory (the memory M2). Note that in the panel 1 shown in FIG. 1 the memory selection keys 8a, 8b described as MEMO1 and MEMO2 are disposed as one group, and the memory selection keys 8c, 8d described as MEMO3 and MEMO4 are disposed as another group. Specifically, the four memories M1, M2, M3, M4 are divided into two groups of two memories. However, for example, another group of memory selection keys 8e, 8f described with MEMO5 and MEMO6 may be disposed, or memory selection keys 8a, 8b, 8c described as MEMO1, MEMO2, MEMO3 may be disposed as one group, instead of disposing two memories as one group.

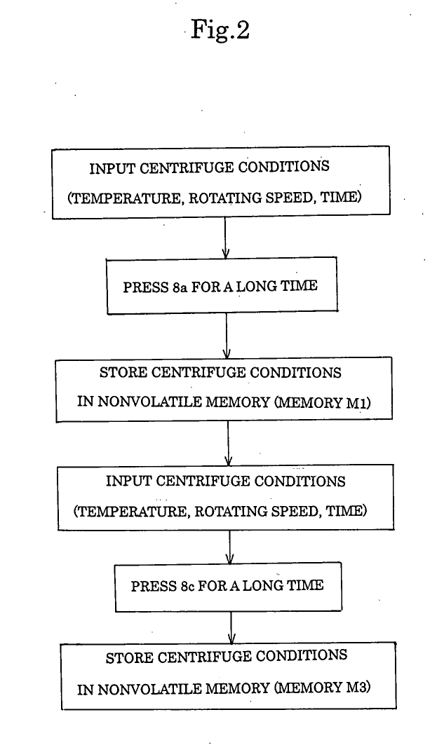

FIG. 2 is a flowchart showing a procedure for storing new operating conditions in the memories M1, M3. A memory element is a rewritable nonvolatile memory. An operating condition of the centrifugal separator is input in a first step, and the memory selection key 8a is pressed for a long time in a second step, whereby a first operating condition is stored in the memory M1 functioning as the nonvolatile memory. Subsequently, another operating condition of the centrifugal separator is input in a fourth step, and the memory selection key 8c is pressed for a long time in a fifth step, whereby a third operating condition is stored in the memory M3 functioning as the nonvolatile memory. In this case, a second operating condition stored in the memory M2 and a fourth operating condition stored in the memory M4 are not changed.

The order of executing the operating conditions stored in the memories M1, M2 and the like is specified beforehand, regardless of the order of pressing the memory selection keys 8a, 8b and the like corresponding to the memories M1, M2 and the like. In the centrifugal separator according to the embodiment shown in FIG. 1, the memory selection keys 8a, 8b are disposed as one group, and the memory selection keys 8c, 8d are disposed as another group, as described above. In this embodiment, the memories are called up in ascending order of memory numbers, no matter which memory selection key of the groups is pressed first. In other words, the centrifugal separator is operated such that the memories are called up in ascending order of memory numbers, such as the memory M1, memory M2 and the like, even when the memory selection keys are pressed in the order of the memory selection key 8a and the memory selection key 8b, or vice versa.

The above-described order of specifying the memories for calling up the operating conditions is merely an example. For example, out of the memories that are specified by selecting the memory selection keys, the memories may be specified so as to call up the operating conditions in the order of the memories storing the operating conditions of low rotating speeds (including a rotating speed of 0). Specifically, when a temperature of [4]° C., a rotating speed of [13500] rpm, and an operating time of [10] minutes are stored as the operating conditions in the memory M1, and a temperature of [4]° C., a rotating speed of [0] rpm, and an operating time of [5] seconds are stored as the operating conditions in the memory M2, the memory M2 storing the operating condition of low rotating speed may be called up first, regardless of the order of pressing the memory selection keys 8a, 8b, and thereafter the operating condition of the memory M1 may be called up. Note that the memory selection keys are pressed in a normal way for a short period of time, and not pressed for a long time (approximately three seconds, for example) to specify the memories to store the operating conditions as described above.

In addition, in the embodiment shown in FIG. 1, light-emitting diodes L1, L2, L3, L4 are provided in the vicinity of the characters “MEMO1,” “MEMO2,” “MEMO3,” “MEMO4,” respectively, which are the memory selection keys 8a, 8b, 8c, 8d. When the memory for storing or calling out the operating condition is specified by pressing any of the memory selection keys 8a, 8b, 8c, 8d, the corresponding light-emitting diode L1, L2, L3, L4 emits light. Furthermore, during a period in which the centrifugal separator is operated under the operating condition stored in any of the memories, the corresponding light-emitting diode L1, L2, L3, L4 emits light. As a result, the selected memory, namely, the memory that stores the operating condition currently operating the centrifugal separator, can be found. For example, when the operating condition stored in the memory M3 is called up by pressing the memory selection key 8c, or during a period in which the centrifugal separator is operated under the operating condition stored in the memory M3, the light-emitting diode L3 disposed in the vicinity of the character “MEMO3” emits light by lighting up or blinking.

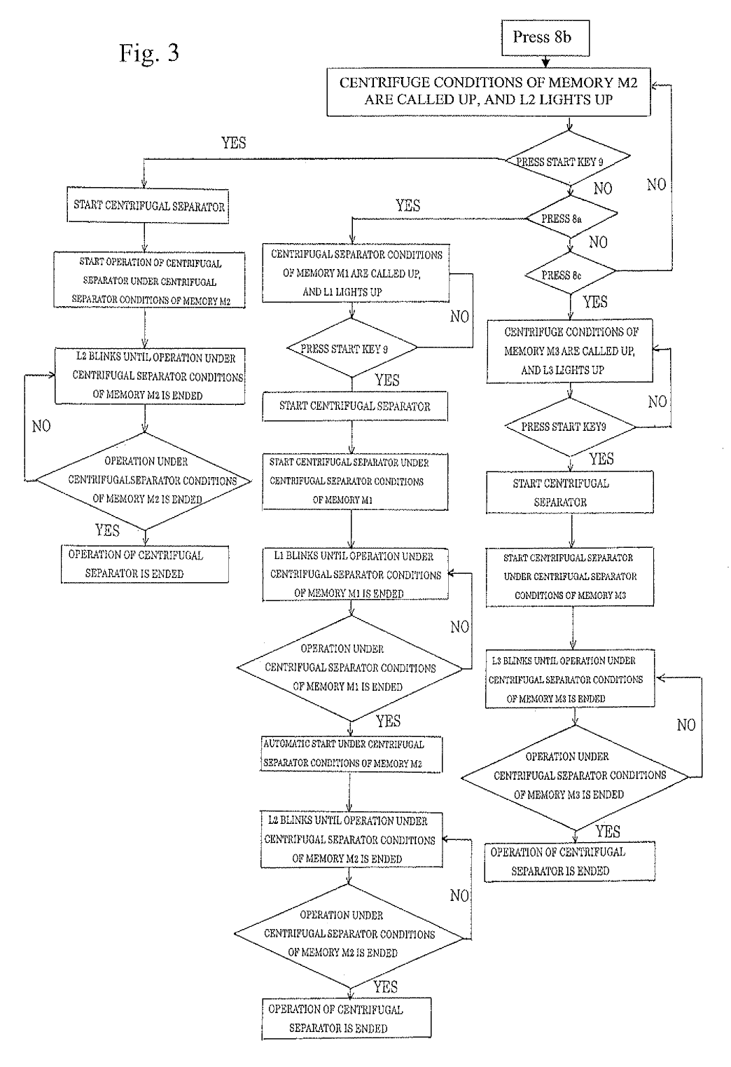

FIG. 3 is a flowchart showing an example of operating the centrifugal separator.

As shown in FIG. 3, when the memory selection key 8b corresponding to the memory M2 is pressed in a state in which the operating conditions are stored in the memory M1 to memory M4, the operating condition stored in the memory M2 is called up and displayed on the parameter value display part 1b, and the light-emitting diode L2 lights up. Subsequently, when a start key 9 is pressed (the state shown in the left column of the flowchart), the operation of the centrifugal separator is started under the operating condition of the memory M2, and the light-emitting diode L2 continues to blink until the operation under this operating condition ends, whereby the currently executed operating condition is displayed as the operating condition stored in the memory M2. Once the operation under the set operating condition of the memory M2 is ended, the emission state of the light-emitting diode L2 is switched back to the lighting state, which is the state immediately before pressing the start key 9, and thereby the operation is ended.

On the other hand, when the memory selection key 8a corresponding to the memory M1 is pressed without pressing the start key 9 and after the memory selection key 8b corresponding to the memory M2 is pressed, the operating condition stored in the memory M1 is called up and displayed on the parameter value display part 1b, and the light-emitting diode L1 lights up. Then, when the start key 9 is pressed (the state shown in the middle column of the flowchart), the operation of the centrifugal separator is started under the operating condition of the memory M1 having a low memory number, regardless of the order of pressing the memory selection keys. The light-emitting diode L1 continues to blink until the operation under this operating condition ends, whereby the currently executed operating condition is displayed as the operating condition stored in the memory M1. Once the operation under the operating condition of the memory M1 is ended, the operation of the centrifugal separator is automatically continued under the operating condition stored in the memory M2, the light-emitting diode L2 continues to blink until the operation under this operating condition ends, whereby the currently executed operating condition is displayed as the operating condition stored in the memory M2. Once the operation under the set operating condition is ended, the emission state of all of the light-emitting diodes L1, L2 is switched back to the lighting state, which is the state immediately before pressing the start key 9, and thereby the operation is ended.

Moreover, when the memory selection key 8b corresponding to the memory M2 is pressed first and subsequently the memory selection key 8a corresponding to the memory M1 is pressed, and thereafter the memory selection key 8c corresponding to the memory M3 is pressed, the operating condition stored in the memory M3 is called up and displayed on the parameter value display part 1b, and the light-emitting diode L3 lights up. Then, when the start key 9 is pressed (the state shown in the right column of the flowchart), selection of the memory selection keys 8a, 8b of the group different from the memory selection key 8c is ignored, regardless of the order of pressing the memory selection keys, the selection being performed immediately before pressing the start key 9. The operation of the centrifugal separator is started under the operating condition of the memory M3 corresponding to the memory selection key 8c, the light-emitting diode L3 continues to blink until the operation under this operating condition ends, whereby the currently executed operating condition is displayed as the operating condition stored in the memory M3. Once the operation under the set operating condition of the memory M3 is ended, the emission state of the light-emitting diode L3 is switched back to the lighting state, which is the state immediately before pressing the start key 9, and thereby the operation is ended.

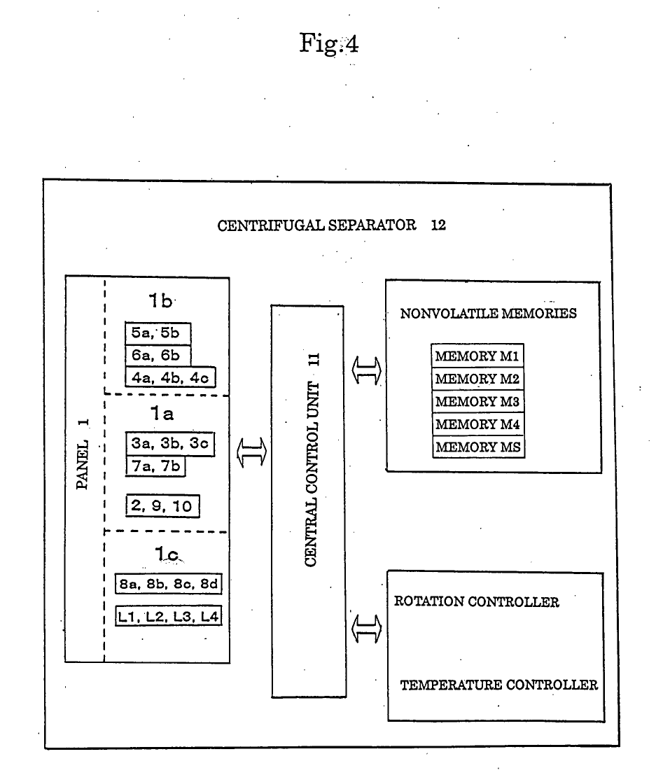

FIG. 4 is a block diagram of an electronic circuit corresponding to the embodiment shown in FIG. 1. A central control unit 11 is connected to, within the panel 1, the operating condition selection keys 3a, 3b, 3c, the temperature display means 4a, the speed display means 4b, the operating time display means 4c, the rotation speed mode display means 5a, the centrifugal acceleration mode display means 5b, the minute unit mode display means 6a, the second unit mode display means 6b, the set value increase key 7a, the set value decrease key 7b, the memory selection keys 8a, 8b, 8c, 8d, the power switch 2, the start key 9, a stop key 10, the light-emitting diodes L1 to L4, and the nonvolatile memories. The nonvolatile memories have the memory M1, memory M2, memory M3, memory M4, and a sequence memory MS for storing the order of executing the operating conditions of the respective memories. The central control unit 11 incorporates a program for executing the data processing described above in detail, and controls the operations of a rotation controller and temperature controller of a centrifugal separator 12 in accordance with the program.

In the centrifugal separator according to the present invention described above, the keys for specifying the memories storing the operating conditions and the keys for specifying the memories calling up the operating conditions are the same memory selection keys 8a, 8b, 8c, 8d. Therefore, an extremely good operability is achieved, the space for the panel can be saved, and the cost can be reduced. In addition, because the order of memories for calling up the operating conditions is previously specified regardless of the order of selecting the memory selection keys, the centrifugal separator can be continuously operated reliably in different order of specific operating conditions, such as in the order of the operating conditions in which the rotating speed is always low.

Although the above has described the centrifugal separator according to the present invention, the present invention is not limited to the embodiment described above, and it goes without saying that various modifications and changes can be made within the scope of the technical ideas of the present invention that are described in the patent claims.

What is claimed is:

1. A centrifugal separator, which stores operating conditions in a plurality of memories respectively and independently or continuously calls up the operating conditions stored in the memories, to perform operation control,
wherein a plurality of memory selection keys corresponding to the plurality of memories are provided, and the memories for storing the operating conditions therein and the memories for calling up the operating conditions are specified by selecting the memory selection keys.

2. The centrifugal separator according to claim 1, wherein an order of the memories for calling up the operating conditions is previously specified, regardless of an order of selecting the memory selection keys.

3. The centrifugal separator according to claim 2, wherein the memories are divided into a plurality of groups, and the order of the memories for calling up the operating conditions is previously specified in each of the groups of the divided memories.

4. The centrifugal separator according to claim 2 or 3, wherein the order of the memories for calling up the operating conditions is previously specified such as to call up the operating conditions in ascending order of memory numbers of the memories specified by selecting the memory selection keys.

5. The centrifugal separator according to claim 2 or 3, wherein the order of the memories for calling up the operating conditions is previously specified such as to call up the operating conditions in the order of the memories storing operating conditions of low rotating speeds, out of the memories specified by selecting the memory selection keys.
